(19) United States
(12) Patent Application Publication
(10) Pub. No.: US 2007/0162569 A1
(43) Pub. Date: Jul. 12, 2007

(54) SOCIAL INTERACTION SYSTEM

(75) Inventors: Merle Michael Robinson, Redmond, WA (US); Eric James Hennings, Seattle, WA (US)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: ICEBREAKER, INC., St George Town (KY)

(21) Appl. No.: 11/456,397

(22) Filed: Jul. 10, 2006

Related U.S. Application Data
(60) Provisional application No. 60/757,280, filed on Jan. 9, 2006.
(60) Provisional application No. 60/806,833, filed on Jul. 10, 2006.

(51) Int. Cl. G06F 15/16

(52) U.S. Cl. 709/219

(57) ABSTRACT

A mobile social interaction system that enables users to communicate to desired candidates via handheld and/or mobile devices is provided. User profiles or other criteria can be employed in order to facilitate matching candidates. The innovation enables the users to anonymously communicate via voice, video and/or text messaging communications. Additionally, the innovation provides for the ability to record a state, suspend an application/service based upon the state at commencement of a communication, and restore the application to the recorded state upon termination of the communication.

### CROSS-REFERENCE TO RELATED APPLICATIONS

This application claims the benefit of U.S. Provisional Patent application Ser. No. 60/757,280 entitled “MOBILE SOCIAL NETWORK”, filed on Jan. 9, 2006 and Ser. No. 60/806,833 entitled “MOBILE SOCIAL NETWORK”, filed on Jul. 10, 2006. The entireties of the above-noted applications are incorporated by reference herein.

### BACKGROUND

The Internet continues to make available ever-increasing amounts of information which can be stored in databases and accessed therefrom. Additionally, with the proliferation of portable terminals (e.g., notebook computers, cellular telephones, personal data assistants (PDAs), smartphones and other similar communication devices), users are becoming more mobile, and hence, more reliant upon information accessible via the Internet. Accordingly, the connectivity available via the Internet is frequently used to chat, socialize and communicate with friends and family.

One particular area in which the Internet is becoming popular is in the field of Internet dating and other social interaction services generally. An Internet dating service, or online dating, allows people to meet and get acquainted online thereafter potentially engaging in a romantic relationship. Conventional dating services are oftentimes moderated by a third party who matches candidates based upon criteria and/or preferences.

These online dating services enable a user to create a profile which can contain information relating to physical as well as personal characteristics. As well, these online dating services enable a user to search profiles of other candidates in order to locate a match based upon a predetermined set of criterion. For example, a user can search upon physical characteristics such as age, height, weight, hair color, etc. As well, personal characteristics such as income, interests, hobbies, religion, etc. can be used to search profiles.

Online dating or Internet dating continues to expand in popularity as more and more people become acquainted with the Internet and its vast communication resources. Effectively, the seemingly anonymity of the Internet alleviates much of the apprehension and pressures associated with face-to-face communication felt by many individuals. As stated above, the overall structure of online dating services enables a person to post a personal profile and to respond to requests without ever speaking a word. Rather, all initial communication is of the form of a text messages and replies thereto. Most often, this communication is un-moderated which, unfortunately, enables untruthfulness and lack of full disclosure. For instance, in accordance with the profiles, it is not uncommon for a participant to be untruthful with respect to personal characteristics such as, age, height, weight, income, profession, etc. This untruthfulness can extend to un-moderated communication as well.

In all, online dating or internet dating services enable people to meet online and possibly develop a friendship, a romantic or even sexual relationship. These online dating services enable individuals to provide personal information, for example, age, gender and location. Accordingly, the services promote others to search these individuals using the profile criteria. As well, many dating services allow members to include a photo in their profile which can be search by others. Oftentimes, online matchmaking sites offer additional services, such as online chats, and message boards.

In general, online dating services operate by the same criteria as typical relationships. However, factors specific to the nature of online communications may affect the experience. There are many positive factors that can inherently enhance the online experience. For example, online dating sites facilitate individuals to meet more people than they would without such sites. As well, online matchmaking site enable individuals to easily browse other members' profiles before deciding to initiate communication.

Additional positive factors include the ability to communicate anonymously and with reduced fear or social awkwardness. All in all, these online dating services enable users to break down geographic barriers while enabling users to learn more about a prospect or candidate before actually expending the time and effort to pursue a meeting. In today's busy society, the value added by the ability to pre-screen candidates is very desirable.

However, the aforementioned positive effects do not come without drawbacks. One of the most common negative effects of online matchmaking services is that people often misrepresent themselves. For example, it is not uncommon for individuals to be untruthful about their marital and/or relationship status, age, gender, physical attributes or socioeconomic status. The mere post of a profile makes it easy for a user to be untruthful about individual criteria as well as to post a photo that is not current or even a photo that is not really that of the individual.

Conventional dating services have begun to migrate into today's mobile society. More particularly, recent developments have been directed to employing matchmaking services via mobile devices such as cell phones, smartphones, etc. However, because these conventional mobile systems are nothing more than a mobile version of the traditional Internet dating systems, they have been plagued with slow response time, widespread deception and lack of interactivity.

Additionally, because today's mobile systems are built upon traditional personal computer-based dating platforms, they do not effectively conform to and/or leverage the capabilities of the mobile device. Thus, they do not adapt well to the particular requirements and capabilities of today's mobile devices. For example, because the display size of a mobile device is limited with respect to the PC, scaling of the user interface in accordance with the mobile device limitations is often required. Conventional systems overlook this critical scaling requirement.

Currently, users of mobile phone social interaction services, such as mobile phone dating, are limited to text messaging to the people with whom they connect. Text messaging can be a very inefficient way to communicate particularly for long periods of time and/or for very long messages. On the other hand, in one scenario, when users wish to switch to voice calls, oftentimes they must text message their phone numbers thereby exposing their identities.

In accordance with this conventional process, the users forego the security of the anonymity offered by traditional online matchmaking services. Anonymity is valuable in that inherently breaks down communication barriers by providing the ability to get to know someone before actually revealing identity.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a mobile social interaction service that enables users to communicate to desired individual(s) (e.g., candidates) via handheld and/or mobile devices. It will be understood and appreciated that the user profiles or other criteria can be employed in order to facilitate matching candidates.

In one aspect, the innovation enables the users to anonymously communicate via voice communications. In another aspect, the innovation provides for anonymous video communication. In yet another aspect, the innovation provides for anonymous text messaging communication.

Still other aspects of the subject innovation provides for the ability to schedule a time for a meeting (e.g., call) with one or more members of a service. Additionally, upon arrival of the scheduled time, if the application is not currently active, the system can automatically launch the application/service or alternatively, prompt a user with regard to launching the application. Accordingly, the novel systems described herein can be employed to facilitate making (e.g., scheduling) a date, meeting or encounter. It is to be understood and appreciated that “date” is used herein to describe any social encounter without regard to any physical involvement of a romantic encounter.

Other aspects are directed to a novel mechanism of recording the state of the service or application prior to commencement of a meeting. Therefore, upon commencement of the meeting, the service or application can be suspended in accordance with the state. Upon termination of the meeting or call, the service can be restored to the state just prior to the commencement of the meeting.

In yet another aspect thereof, an artificial intelligence (AI) component is provided that employs a probabilistic and/or statistical-based analysis to infer an action that a user desires to be automatically performed. For example, AI can be employed to automatically select candidates and/or schedule a meeting.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates anonymous voice communication in a social matching environment in accordance with an aspect of the innovation.

FIG. 2 illustrates an exemplary communication exchange between two wireless devices in accordance with the novel subject matter of the innovation.

FIG. 3 illustrates an exemplary flow chart of procedures that facilitate anonymous communication in accordance with an aspect of the innovation.

FIG. 4 illustrates an exemplary flow chart of procedures that facilitate suspending an application/service with respect to an anonymous voice communication in accordance with an aspect of the innovation.

FIG. 5 illustrates an alternative communication system that facilitates suspending and restoring a service based upon a state in accordance with an aspect of the innovation.

FIG. 6 illustrates an alternative communication system that facilitates selection of a candidate and launching of an application in accordance with an aspect of the innovation.

FIG. 7 illustrates an alternative communication system that facilitates anonymous audio, video and/or text communication in accordance with an aspect of the innovation.

FIG. 8 illustrates an alternative system diagram having a server that includes a connection manager that facilitates control of the anonymous communications between devices in accordance with an aspect of the novel subject matter.

FIG. 9 is a schematic block diagram of a portable handheld device according to one aspect of the subject invention.

FIG. 10 illustrates an architecture of a portable handheld device including an artificial intelligence-based component that can automate functionality in accordance with an aspect of the invention.

FIG. 11 illustrates an exemplary failsafe application restart process flow in accordance with an aspect of the innovation.

FIG. 12 illustrates a block diagram of a computer operable to execute the disclosed social interaction service architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

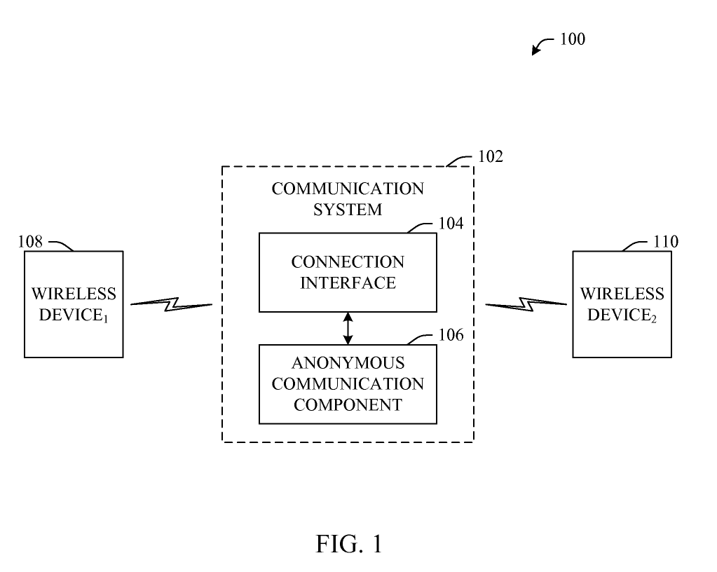

Referring initially to FIG. 1, the subject innovation is directed to a system 100 (and method) that facilitates anonymous communication between one or more wireless device users. For example, in disparate aspects, the system 100 can facilitate anonymous voice chat, video chat, and/or text chat. By way of further example, the novel aspects described can be employed to effectuate social interaction games that include communication via voice, video, text or any combination thereof.

Additionally, the system 100 illustrated in FIG. 1 can facilitate suspension of a social service upon commencement of a communication session. Accordingly, upon termination of the communication session, the novel system 100 can restore the application based upon the state of the service at the time of suspension. In operation, the state can be transferred to the communication system thus enabling a user the ability to continue to interact with the system.

By way of example, a user might desire to have background music play during the communication system phase. By using a data/internet based system and their cell phone they might program a playlist. Upon commencing communication, the user would then be transferred to the communication system and their music would be playing. If they wanted to skip ahead in their play list they could do so using communication system voice or touch tone commands, for example, “press 1 to skip ahead”. After the communication system ends the state information would transfer back the data component which could examine the modified state information and offer to remove songs that the user skipped from the playlist so that they would not be played in the future.

The following scenarios are directed to a social interaction services (e.g., matchmaking) scenario. While the use of this technology in this social interaction service space is novel, it is to be understood and appreciated that the novel functionality (e.g., anonymous communication, service suspension/restoration) can be employed in connection with any scenario where a service is employed to connect parties and/or anonymous communication is desired. By way of example, the novel systems and functionality of the innovation can be employed in social support scenarios including, but not limited to, suicide, domestic violence, and eating disorder information, support and treatment scenarios. Although the scenarios described in detail herein are directed to social interaction service applications, the additional uses and scenarios by which the novel functionality can be employed are to be included within the scope of this innovation and claims appended hereto.

Generally, system 100 can include a communication system component 102 that can facilitate the novel anonymous communication and service suspension functionality of the innovation. As shown, the communication system component 102 can include a connection interface component 104 and an anonymous communication component 106. The functionality of each of these components will be described in greater detail with respect to the figures that follow.

As illustrated in FIG. 1, the communication system component 102 can be employed to anonymously connect at least two wireless devices (108, 110). It will be understood upon a review of the figures that follow that the communication system component 102 can be employed to connect more than two devices as desired. By way of example, the communication system component 102 can be employed to connect parties in a chat room environment where anonymity is desired.

Referring again to the subcomponents (104, 106) of the communication system component 102, the connection interface component 104 can manage details with respect to a desired communication. For instance, the connection interface 104 can be employed to identify the parties, schedule or connect the communication session, suspend and/or restore a social service, etc. More particularly, as shown in the figures that follow, the connection interface 104 can include the service that effectuates locating and selecting a party (e.g., candidate) for which to connect.

In operation, the connection interface component 104 interacts with the anonymous communication component 106 in order to effectuate the desired communication session. As described supra, this communication session can be a voice communication session, a video communication session, a text messaging communication session or any combination thereof. All in all, it will be understood that it is a novel feature of the innovation to enable two parties to agree to communicate thereafter being connected anonymously via the communication system component 102.

It is to be understood that walkie-talkie or push-to-talk (PTT) methods can be employed in connection with the functionality described herein. More particularly, PTT refers to an audio input feature that can be employed in connection with a mobile phone. PTT enables the mobile phone to function as a digital two-way radio (e.g., walkie-talkie) when employing PTT operation. Upon pressing a PTT button, a user can input an audio message that can be heard by one or several parties instantly. For example, one-to-one or one-to-many communication can be accomplished in a PTT scenario. It is to be appreciated that the PTT functionality in connection with the current innovation can be employed within the same service (e.g., carrier) or across services.

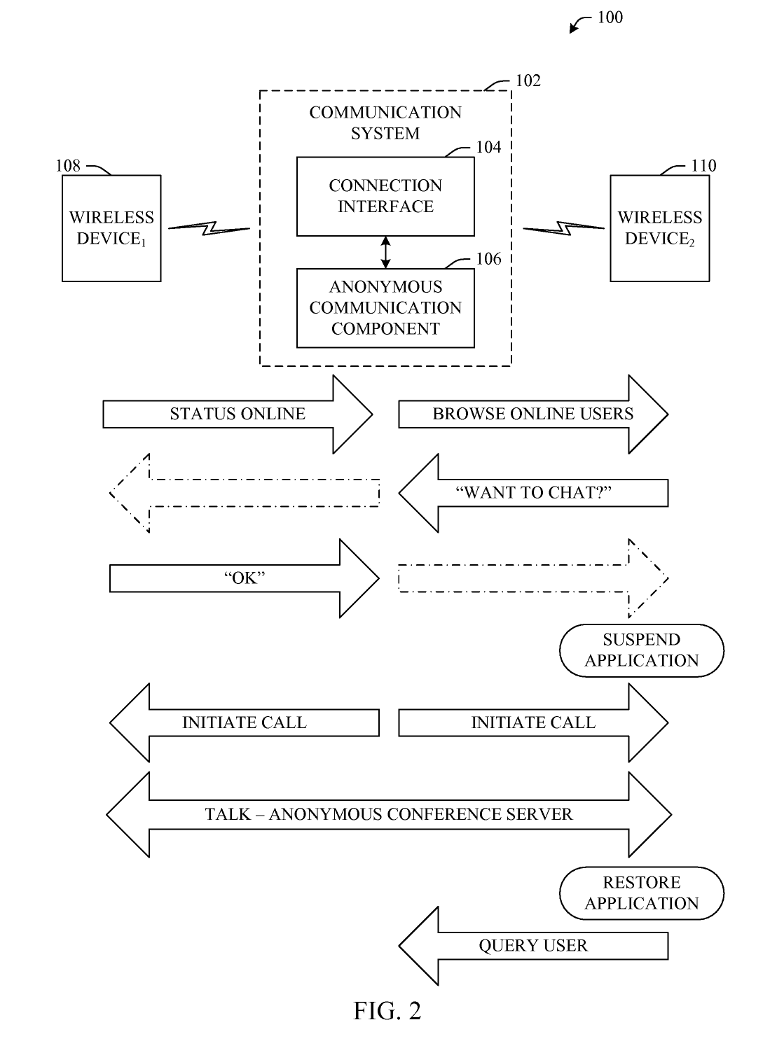

Turning now to FIG. 2, an exemplary communication exchange between two wireless device users (108, 110) in accordance an aspect of the innovation is shown. As described above, although this exchange is directed to an exchange between two users (108, 110), it is to be understood that the novel exchange can be employed in connection with any number of users in alternative aspects. To this end, it will be understood that the novel features of anonymous communication and application or service suspension/restoration can be employed in connection with any network of users.

Moreover, it will be understood that any wireless communication devices can be employed in connection with alternative aspects. By way of example and not limitation, the wireless devices (108, 110) shown can be cell phones, smartphones, personal data assistants (PDAs), laptops, personal computers (PCs) or the like. Although the scenarios described herein are directed to employing the novel functionality in connection with “wireless” devices, it will be understood that other wired devices can also employ the novel functionality described herein. By way of example, the innovation can be employed to initiate, transfer or forward a call to a conventional landline of choice.

In a more specific example, in an aspect, the innovation provides for the ability for a user click on a link to call somebody and have the landline ring (rather than the wireless device as described in detail herein). In accordance with still another aspect of the innovation, suppose a user is surfing on the Internet using a PC, the user can select another user to speak to by employing a navigation device such as a mouse or trackball. Subsequently, the user can be connected via a landline or even via headphones and microphone on the PC using VOIP capabilities. All in all, the novel functionality of the innovation can be employed via any communication device (wired or wireless, or combinations thereof) known in the art without departing from the scope of this disclosure and claims appended hereto.

As shown in FIG. 2, a first wireless device user (e.g., 108) can launch a service within the communication system component 102. As will be described herein, the user can launch a social interaction service or application. Once the social interaction service is launched, the user can browse profiles associated with online users. In the scenario of a social interaction service, the first wireless device user (e.g., 108) can browse all online (or enrolled) candidates.

In accordance with the scenario of FIG. 2, the first user can select a second user (e.g., 110). Thus, the second user can send a message to invite the first user to talk by sending the message “want to talk?” In reply, the first user can accept the invitation by sending a message to the effect of “OK.” At this point in the operation, the novel communication system component 102 can record the state of the social interaction service application and suspend the application in accordance with the state.

By way of more specific example, once the invitation is accepted and the connection is commenced, the state can be recorded. The state can reflect a users place within the application such as, a specific candidate filter, a short list of candidates, etc. By suspending the application, the user will be able to continue within the social interaction session at the place in time preceding the acceptance of the invitation.

Once the state is recorded, as shown, the anonymous communication session (or call) can be initiated. As described above, this anonymous communication session can be a voice call, a video call, a text messaging session, or combination thereof As illustrated, in this scenario, the users (108, 110) can talk via the anonymous conference server (e.g., communication system component 102).

Upon termination of the communication session, the social interaction application can be restarted based upon the recorded state at the time of the service suspension. It is to be understood that by restoring the application to the state just prior to initiation of the call, a user can continue where they left off. For example, a user can be queried for information such as candidate feedback, etc. This example illustrates the value of restoring the application to the suspension state. By doing so, the user will be returned to the profile of the called candidate. This makes supplying feedback, ranking, etc. much easier.

It will be appreciated that the aforementioned novel functionality is inherently difficult because most conventional wireless devices (e.g., cell phones) do not allow voice calls and data services to run simultaneously. For at least this reason, conventional systems cannot enable the seamless transition between a social interaction application and a voice call. As described above, in one aspect, the innovation can suspend and restart the data service to create a seamless experience for the users when a phone call is activated. This is partly due to the fact that data services generally end when a phone call is activated.

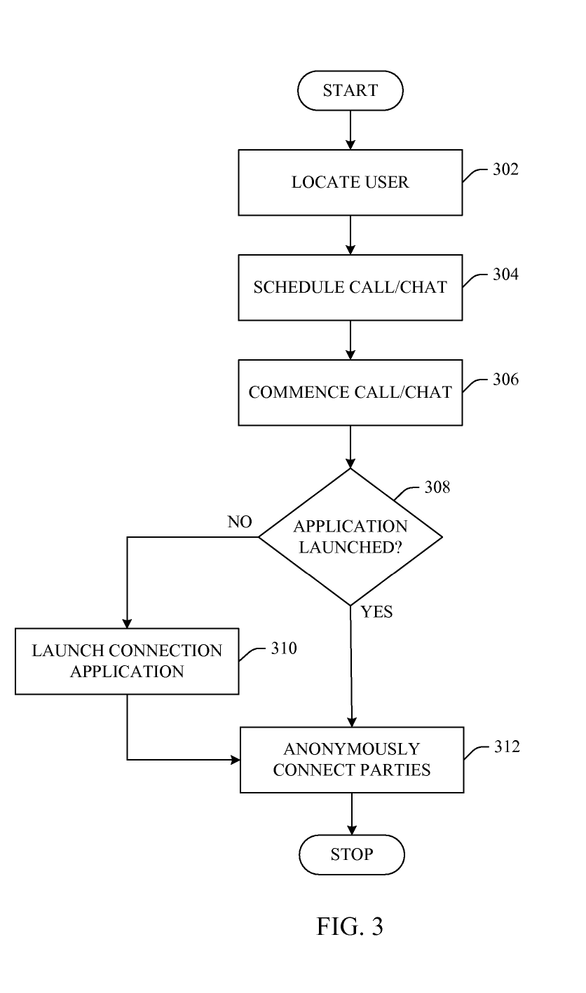

FIG. 3 illustrates a methodology of the anonymous communication with respect to a social interaction application in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 302, a user can be located via the service of a social interactive system or other social application. Once a candidate (or group of candidates) is identified, a call (or chat) can be scheduled at 304. For example, the call/chat can be scheduled for a time convenient to the parties involved.

The call/chat can be commenced or initiated at 306. In other words, the call can be initiated in accordance with a schedule set forth in 304. More particularly, the schedule can be set to automatically commence the call at a particular time/date. At 308, a decision can be made at 308 if the necessary application is launched in order to commence the call. More particularly, in a scenario, a user can employ a social interaction service application to schedule the call at 304. However, at the scheduled time, the application may not be active therefore requiring a prompt or auto-launch to make the application available to accomplish the connection.

If, at 308, it is determined that the application is not pre-launched, the connection application (e.g., social interaction service application) can be launched at 310. On the other hand, if the application is pre-launched (or launched at 310), the parties can be anonymously connected at 312. Following, a stop block is reached.

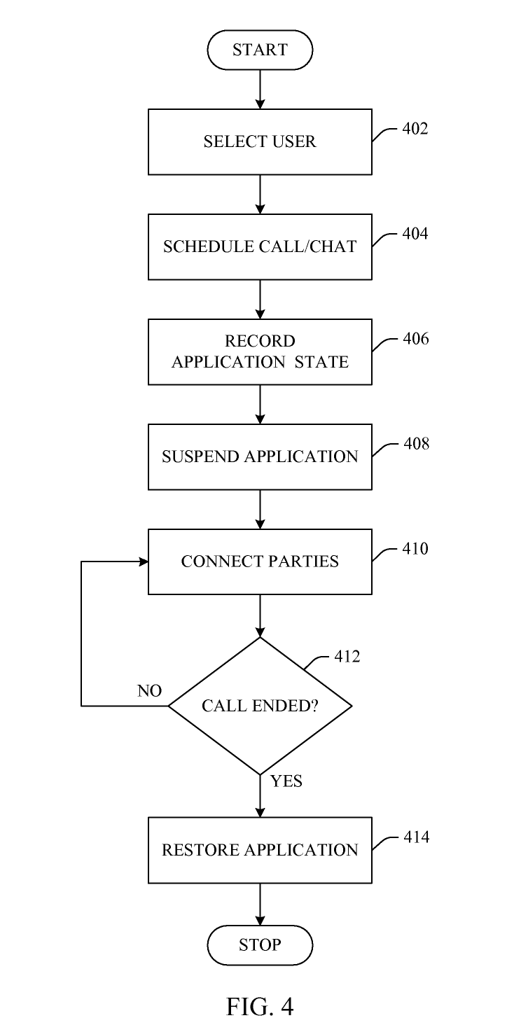

FIG. 4 illustrates a methodology of the novel seamless transition between the service and the anonymous communication in accordance with an aspect of the innovation. At 402, one user can select another, can select a group of users, or the parties can mutually select each other. This selection can be effectuated via a social interaction service application. At 404, a call can be scheduled between the parties. Here, users (two or more) agree to engage in an anonymous communication (e.g., voice call). The parties can schedule the call to occur immediately, or at some later time. As well, when the call is scheduled, the parties can determine if the call is to last for a specific period or be indefinite in time, depending upon the service prescription and/or user decisions.

Upon arrival of the scheduled time, at 406, the state of the service or social interaction service application is recorded. Subsequently, the social interaction service application can be suspended at 408. In other words, the application can be halted at the point where the user was when the call was initiated.

Next, the parties can be connected at 410. As described with reference to FIG. 3, the parties can be anonymously connected at 410. Furthermore, it will be understood that this connection can be a voice call, a video call and/or a text message chat. A determination is made at 412 if the communication (e.g., call) has ended. If the call has not ended, the system returns to 410 and maintains the connection of the parties in accordance with the schedule set forth in 404.

Once the call terminates, the service can be restored at 414. In other words, the recorded state can be recalled thereby effectuating the restoration of the application in accordance with the state just prior to the commencement of the communication. Next, a stop block is reached.

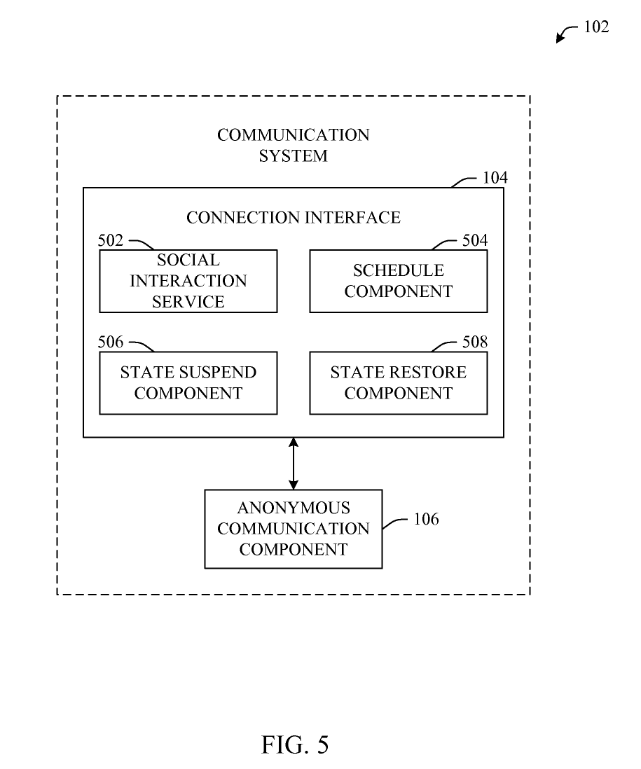

Turning now to FIG. 5, an alternative block diagram of communication interface component 102 is shown. As described with reference to FIG. 1, the communication interface component 102 can include a connection interface component 104 and an anonymous communication component 106.

As shown in FIG. 5, the connection interface component 104 can include a social interaction service component 502 and a schedule component 504. Although the social interaction service component 502 is shown inclusive of the connection interface component 104, it is to be understood that this component 502 can be located external and/or remote from the connection interface component 104 (and communication system 102) in alternative aspects.

In one particular aspect, the social interaction service component 502 can be representative of a mobile dating service where members/candidates can enter a profile of themselves and/or browse profiles of other members/candidates. Although a mobile dating service is described herein, it is to be understood that the novel features (e.g., anonymous communication and service suspension/restoration) can be employed in other scenarios where an application or service is used to schedule a conversation or meeting between individuals.

As well, it is to be appreciated that the novel innovation discloses an ability to provide simultaneous data and voice paths. For instance, the innovation can be used in a scenario where a user employs a PC and a phone simultaneously. More particularly, the innovation can be employed when the PC is used for VOIP communication and the phone is a landline. Those skilled in the art will be able to appreciate other aspects that can utilize the novel functionality described herein. As such, these additional aspects are to be included within the scope of this innovation and claims appended hereto.

As well, it will be understood that the primary novel features of the innovation can be practiced independently of one another. By way of example, the innovation can be employed to anonymously connect individuals without suspending the underlying application/service. Similarly, the innovation can be employed to connect individuals by revealing their identities but, nonetheless, suspending and later restoring the underlying application/service as described supra.

Continuing with the discussion of the connection interface component 104 of FIG. 5, a schedule component 504 can be provided that enables users to schedule a meeting (e.g., conversation). For instance, a conversation can be scheduled for a time and date that is convenient to each of the parties. Similarly, in a disparate scenario, a meeting can be scheduled to take place in a virtual “chat room” or the like. In any case, the schedule component 404 can facilitate identifying a time (and place) that the parties desire to be connected.

As described above, another novel feature of the innovation is the ability to suspend and restart an application and/or service upon commencement and termination of a meeting (e.g., call, chat) respectively. This novel functionality can be effectuated by the state suspend component 506 and the state restore component 508 illustrated inclusive of the connection interface 104. While the state suspend and state restore components (506, 508) are shown as separate components inclusive of the connection interface 104, it is to be understood that the functionality of these components (506, 508) can be co-located within a single component. As well, it will be understood that these components can be external to the connection interface component 104 without departing from the spirit and scope of this innovation and claims appended hereto.

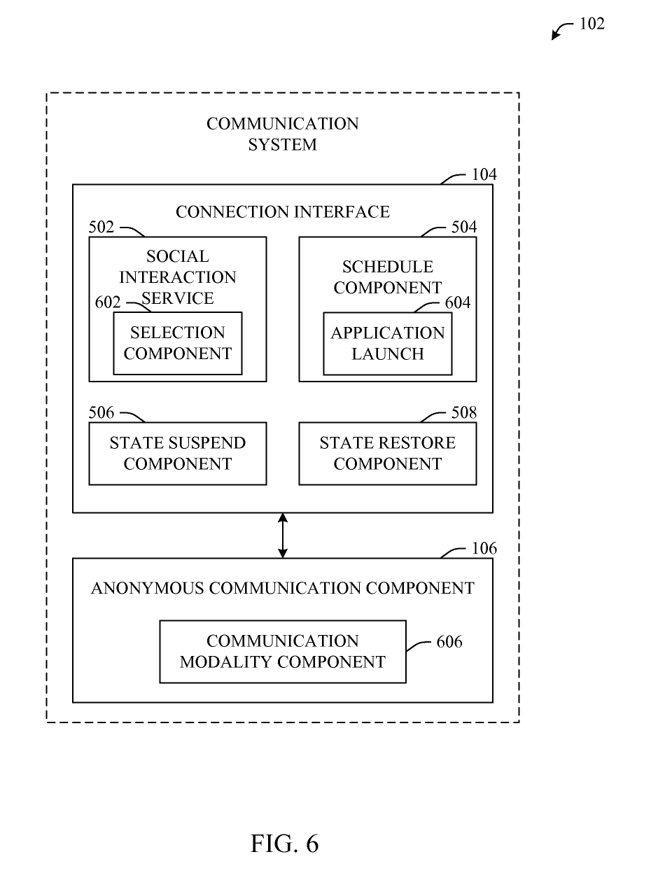

FIG. 6 illustrates yet another exemplary architecture of communication system 102 in accordance with an aspect of the innovation. As shown, the social interaction service component 502 can include a selection component 602 that facilitates selecting parties with whom to connect. In one aspect, this selection component 502 can include a profile browser and user interface (UI) (not shown) which enable scanning of available (e.g., registered, on-line) users' profiles.

Moreover, the schedule component 504 can include an application launch component 604 that facilitates automatically starting the service or application upon commencement of the meeting. For example, a user can schedule a call with another user via the schedule component 504. Once the scheduled time arrives, the application launch component 604 can facilitate automatically launching the application/service necessary to complete the call.

In other words, if one of the parties to the call is not using the application at the time of the scheduled call, the application can be automatically launched. During application launch, the user can be notified of the launch through a user preferred signal such as sound and/or vibration. As well, in aspects, the user can have the option to decline the call and forgo launching the application.

As described above, the state suspend component 606 can record the user's last state just prior to connecting the call. Further, the server will know who to call, when to start the call, and how long the call will last via the selection and schedule components 602, 504. The server will also be able to restart the application on the appropriate screen.

In operation, once the schedule is met, the communication system 102 can commence and subsequently end the call. It will be appreciated that, in accordance with an aspect of the subject innovation, the meeting (e.g., voice call) can begin within seconds of application suspension. To facilitate the expeditious service, the service provider information can be added to the address book to identify the caller to the user. In two exemplary aspects, the technology driving the anonymous call could be a conference server or other suitable bridging system.

The call can end by a server from the service provider or by the users, depending on the application prescription. For example, a conference server could end calls with preset time periods communicated via the schedule component 504. Once the call is ended, the application can be automatically restarted (and restored) by the state restore component 508. In other words, the application will restart at the appropriate screen because the communication system 102 will send the appropriate message to the client phones' processors thereby identifying the stored application state information.

The resultant screen may be the same or different for each of the users on the call, depending upon application needs and/or user preferences. To ensure that the application restarts correctly even when users overpress the “endcall” button or another button, a script can be sent to the client to re-attempt restarts after brief pauses. Similarly, this re-attempt of restarts can be employed in situations of service outage call drops, as well as any other unintentional communication disruptions.

In this scenario, once the script is received, if the user consciously decides to cancel the restart, the system can automatically initiate handling any information requests that would ordinarily occur upon completion of the call. For example, the system can initiate a candidate rating system or the like. Once the system is eventually restarted, aspects can provide for the system to display a default answer or a message upon re-logging into to the application.

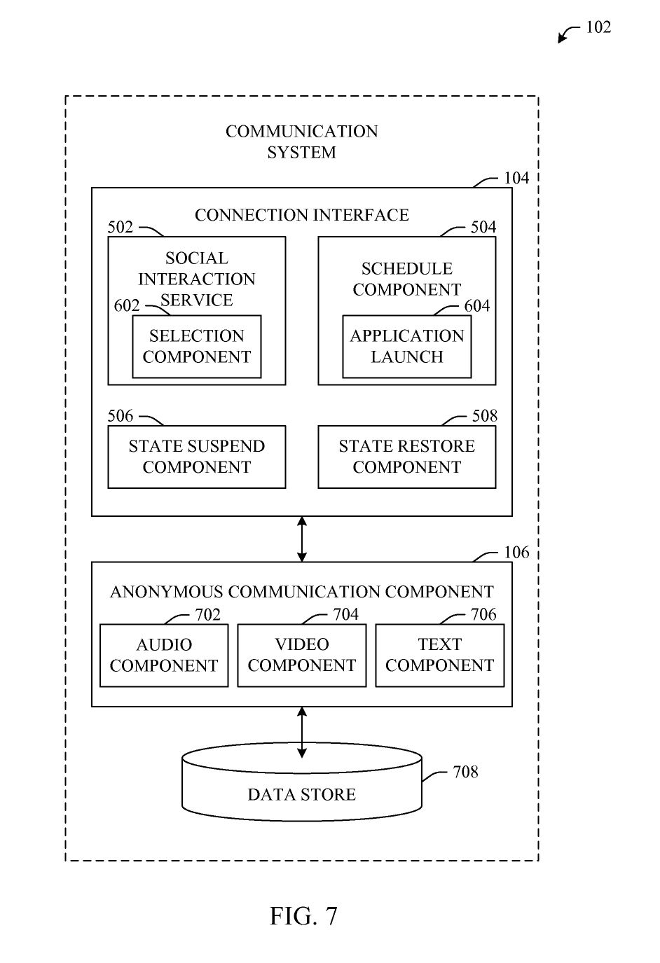

Referring again to FIG. 6, the anonymous communication component 106 can include a communication modality component 606 that represents different communication types. Exemplary communication types are shown in FIG. 7 that follows.

Referring to FIG. 7, the anonymous communication component 106 can include an audio component 702, a video component 704 and/or a text component 706. As can be understood by the name of each component, these sub-components (702, 704, 706) of the anonymous communication component 106 can facilitate anonymous audio, video and text messaging communication respectively.

A data store 708 can be provided within (or external from) the communication interface 102. In operation, if users are unavailable when calls are sent, voice-mails, video mails or text messages can be maintained for listening, viewing or reading later. In order to maintain anonymity, the messages can be linked to the username of the caller, not the real name or phone number. In aspects, users can have all the standard voicemail capabilities: play, stop, rewind, fast forward, delete, save, forward. As an aside, a novel UI can be provided that will use the keypad, but commands can also be accessible using the joystick or other navigation device while viewing the screen.

All in all, the innovation can facilitate a novel seamless transition between a social interaction service and communication functionality. In addition to the novel seamless transition of the innovation, these novel features can be employed in a variety of social interaction service activities such as games or the like. More particularly, novel mobile-based social activities that employ voice functionality as well as activities that do not employ voice functionality are included within the scope of the innovation.

Currently, most downloadable games, for example, Java games, for the mobile phone are solitary games, although it can be particularly desirable to use the phone to interact with others while either playing a game or in another scenario, to pause to receive a call and return to their game. It will be understood that these games can be included within the social interaction service component 502 described above.

Referring now to a discussion of one-to-one video chat experiences in accordance with the novel functionality described herein, currently users of mobile phone social interaction services, such as mobile phone dating, can only text message the people with whom they desire to connect. Text messaging can be a very inefficient way to communicate over very long periods of time and/or for very long messages. Although text messaging functionality is provided, as described above, the subject innovation proposes extending mobile phone social interaction services to include anonymous video calls.

This ability to communicate visually will allow users to get a realtime experience with potential friends and mates. As such, the user will know exactly how a person looks at that time, rather than the conventional use of profile photos which sometimes enabled untruthfulness. Moreover, the innovation proposes a storage system (e.g. data store 708) to help users retrieve previous discussions as well as voice-mails. This storage system can aid users as they try to remember what conversation partners looked like, and how they acted, what they said, etc. As well, when users are not available, video mails can be stored for later viewing.

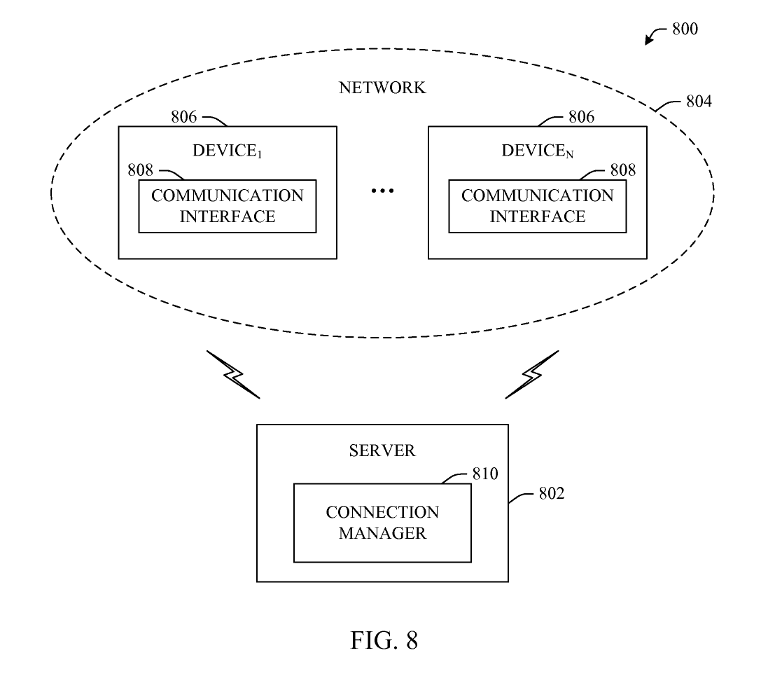

Referring now to FIG. 8, an alternative system 800 in accordance with an aspect of the innovation is shown. Generally, system 800 can include a server 802 and a network 804 having 1 to N devices therein, where N is an integer. Each device can be referred to individually or collectively as device 806. As well, each device 806 can include a communication interface component 808 having the same or similar functionality as communication interface component 102 of FIG. 1. As described herein, it is to be understood that the 1 to N devices 806 can be representative any wireless or wired device capable of interactive communication. As well, it is to be understood that the network 804 can include any combination of wired as well as wireless devices without departing from the spirit and scope of the innovation.

The server component 802 can include a connection manager 810 that controls the communications between devices 806 within the network 804. As well, the connection manager component 810 can control communication via a conventional wired telephone or other communication device. These alternative aspects are to be included within the scope of this innovation and claims appended hereto.

As described with reference to a voice call, a video call can be commenced at any time in accordance with a user preference or a predefined rule. Anonymous video chat can launch through an application or WAP interface via a server (e.g., 802) or via communication interface 808. The video call technology could be pre-integrated into the phone or could be leveraged via the social interaction service provider application. In the former, the video call could be run via a video conference server or other capable device co-located with the mobile operation. In the latter, the application could access a phone's camera to record images, and synchronize the image recording and playback with voice. The voice call could use the mobile operator, or a VoIP technology that uses the phone's built-in microphone.

The following scenario is provided to add perspective to the innovation and is not intended to limit the scope of this disclosure in any way. More particularly, following is a description of more details with respect to the novel anonymous communication functionality of the innovation. As described above, two or more users can set up a call by agreeing to engage in an anonymous voice, video or text conversation. Next, the users can schedule the call, for example, the call can occur immediately, or at some later time. Additionally, it can be determined if the call is to last for a specific period or to be indefinite in length. In aspects, this time constraint can be controlled by and depend upon on the service prescription and/or user decisions.

At the time of the call and with respect to launching the application, the social interaction service provider application may be necessary to enable video chat cases where the application manages the camera and/or provides VoIP. In these cases and if one of the parties to the call is not using the application at the time of the scheduled call, the application can be automatically launched as described above. During application launch, the user can be notified of the launch through a user preferred signal such as sound and/or vibration (or other notifying means).

The system 800 can further provide for anonymous video-mails. If users are unavailable when calls are sent, voice/video-mails can be enabled for listening viewing later. In order to maintain anonymity, the voice/video-mails will be linked to the username of the caller, not the real name or phone number.

In other aspects video chats can be stored and/or searched as desired. Users can have the option to store any and all voice/video chats by setting preferences. These maintenance preferences can include, and are not limited to: all, by user, by type of user (friend or stranger), by discussion, and by discussion type. Additionally, users can decide to record a meeting at the time of the discussion, or right after the discussion. Moreover, the second party may require approval for the voice or video to be recorded. Similar to the above criteria, approval preferences include, but are not limited to: all, by user, by type of user (friend or stranger), by discussion and by discussion type. The second party can also approve the recording at the time of the discussion, or right after the discussion.

Stored chats can be searchable by any criteria, including but not limited to username, date, user-entered keywords (e.g. tags) as well as recognized words and phrases within the message or recording itself. The first two pieces of metadata can be recorded automatically. The keywords can be entered by the users after the call ends. The recognized words and phrases metadata can be generated through speech recognition software or the like. As with voice and video-mails described above, stored video chats can have all the standard playback capabilities as well as “slow-motion.”

Still other aspects of the novel innovation can provide for mobile multi-user anonymous voice and/or video chat. As described above, current users of mobile phone social interaction services are limited to text chat as a way of meeting and interacting with people. As further stated above, text chat on mobile phones is very limiting for a number of reasons. First and foremost, text messaging is difficult to enter the text via a small mobile device keypad. As well, the experience does not feel “real” because users can not see or hear the person as they chat. In other words, as with email communication, text messaging strips the message of any intonation and emotion, or alternatively conveys an unwanted tone and/or emotion. With respect to the social networking, interaction or matchmaking scenario, text messaging further limits the user's ability to detect any “chemistry” with the other party.

In one particular example of the invention, groups of users can initiate and/or join in video chats. These “chat rooms” can allow users to watch and listen to the other members, while doing many of the things that users do today in most text chat rooms, including, but not limited to sending private messages to individual users, and viewing user profiles.

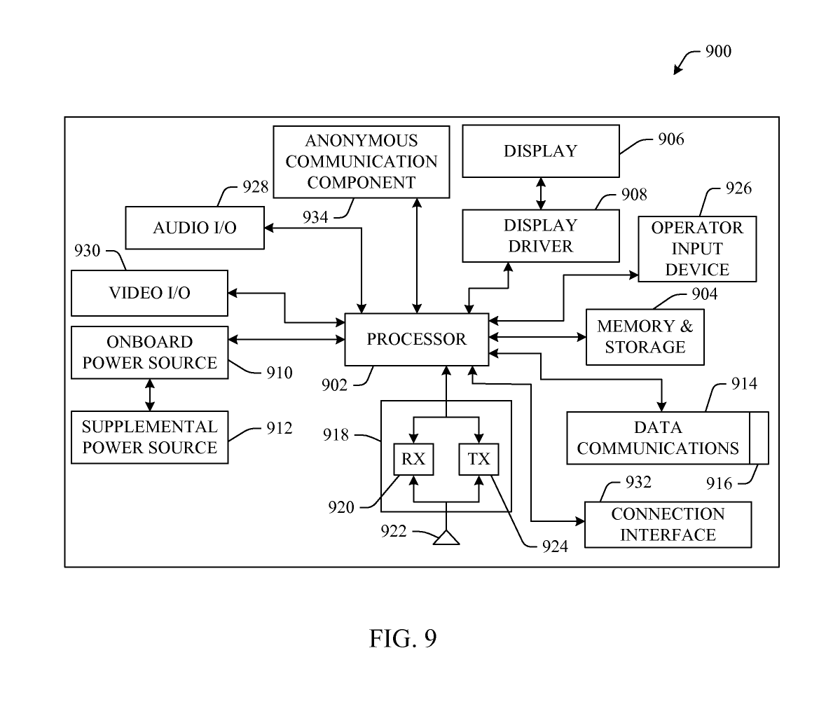

Referring now to FIG. 9, there is illustrated a schematic block diagram of a portable hand-held device 900 according to one aspect of the subject invention, in which a processor 902 is responsible for controlling the general operation of the device 900. The processor 902 can be programmed to control and operate the various components within the device 900 in order to carry out the various novel functions described herein. The processor 902 can be any of a plurality of suitable processors. The manner in which the processor 902 can be programmed to carry out the functions relating to the subject innovation will be readily apparent to those having ordinary skill in the art based on the description provided herein. As will be described in greater detail infra, an artificial intelligence (AI) reasoning component can be used to effect an automatic action of processor 902.

A memory and storage component 904 connected to the processor 902 serves to store program code executed by the processor 902, and also serves as a storage means for maintaining information such as data, services, metadata, device states, electronic mail messages, or the like. The memory 904 can be a non-volatile memory suitably adapted to store at least a complete set of the information that is acquired. Thus, the memory 904 can include a RAM or flash memory for high-speed access by the processor 902 and/or a mass storage memory, e.g., a micro drive capable of storing gigabytes of data that comprises text, images, audio, and video content. According to one aspect, the memory 904 has sufficient storage capacity to store multiple sets of information relating to disparate services, and the processor 902 could include a program for alternating or cycling between various sets of information corresponding to disparate services.

A display 906 can be coupled to the processor 902 via a display driver system 908. The display 906 can be a color liquid crystal display (LCD), plasma display, touch screen display or the like. In one example, the display 906 is a touch screen display. The display 906 functions to present data, graphics, or other information content via a UI. Additionally, the display 906 can display a variety of functions that control the execution of the device 900. For example, in a touch screen example, the display 906 can display touch selection buttons. In operation, when the state is restored, the UI, via display 906, can effectively convey the state of the device.

Power can be provided to the processor 902 and other components forming the hand-held device 900 by an onboard power system 910 (e.g., a battery pack). In the event that the power system 910 fails or becomes disconnected from the device 900, a supplemental power source 912 can be employed to provide power to the processor 902 (and other components (e.g., image capture device)) and to charge the onboard power system 910. The processor 902 of the device 900 can induce a sleep mode to reduce the current draw upon detection of an anticipated power failure.

The device 900 includes a communication subsystem 914 having a data communication port 916, which is employed to interface the processor 902 with a remote computer, server, service, or the like. The port 916 can include at least one of Universal Serial Bus (USB) and IEEE 1394 serial communications capabilities. Other technologies can also be included, but are not limited to, for example, infrared communication utilizing an infrared data port, Bluetooth™, wireless protocols, etc.

The device 900 can also include a transceiver section 918 in operative communication with the processor 902. The transceiver section 918 includes a receiver 920, which receives signals from a remote device via an antenna 922 and can process the signal to obtain digital information therein. The transceiver section 918 also includes a transmitter 924 for transmitting information (e.g., data, service) to a remote device, for example, in response to manual user input via a operator input 926 (e.g., a keypad).

The transceiver section 918 facilitates communication with other portable devices and/or host computer systems. In furtherance thereof, an audio I/O section 928 is provided as controlled by the processor 902 to process voice input from a microphone (or similar audio input device) and can transmit audio output signals (from a speaker or similar audio output device).

In another implementation, the device 900 can provide speech recognition capabilities such that when the device 900 is used as a voice activated device, the processor 902 can facilitate high-speed conversion of the voice signals into text or operative commands. For example, the converted voice signals can be used to control the device 900 in lieu of using manual entry via the keypad 926. As well, in another aspect, voice commands can be employed to effect coupling and/or decoupling from a remote system.

Similarly, video signals can be input and/or output via the video I/O component 932. The video I/O component 932 can include an image capture device capable of providing video communications via the mobile device 900.

Other components such as a connection interface 932 and an anonymous communication component 934 can be provided within the housing of the device 900 to effectuate functionality described supra. For example, the connection interface 932 can be employed in connection with storing a state of the application/service upon connection of a call. As well, the anonymous communication component 934 can be employed to mask the identity of a party to a scheduled meeting.

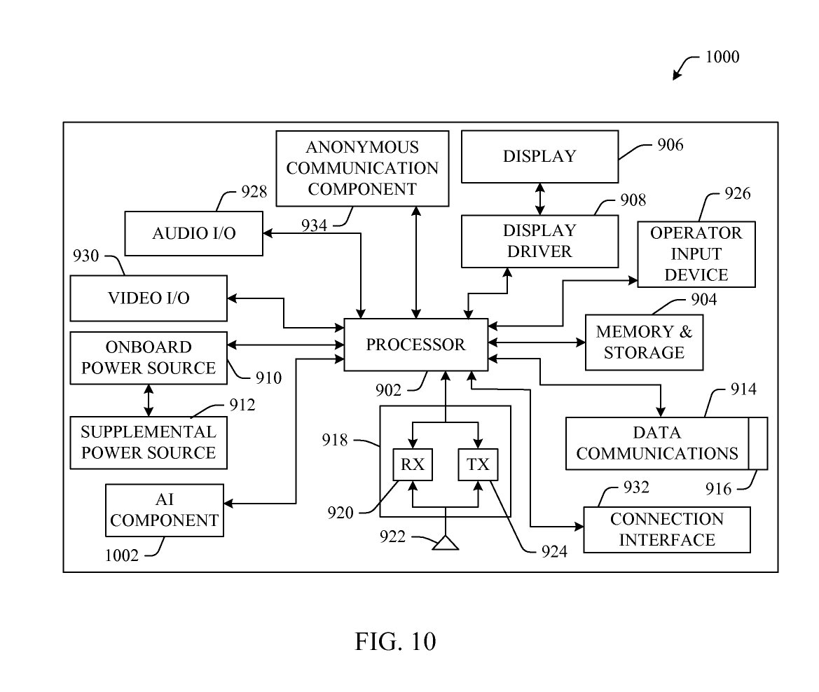

FIG. 10 illustrates a system 1000 that employs an AI component 1002 which facilitates automating one or more features in accordance with the subject innovation. The subject invention (e.g., with respect to selecting candidates, automatically masking identity, monitoring state, selecting a return state, etc.) can employ various AI-based schemes for carrying out various aspects thereof. For example, a process for determining a time to schedule a meeting or a state to which to return the application upon completion of a call can be facilitated via an automatic classifier system and process.

A classifier is a function that maps an input attribute vector, x=(x1, x2, x3, x4, xn), to a class label class(x). A classifier can also output a confidence that the input belongs to a class, that is, f(x)=confidence(class(x)). Such classification can employ a probabilistic and/or statistical-based analysis (e.g., factoring into the analysis utilities and costs) to infer an action that a user desires to be automatically performed.

A support vector machine (SVM) is an example of a classifier that can be employed. The SVM operates by finding a hypersurface in the space of possible inputs that splits in an optimal way the triggering input events from the non-triggering events. Intuitively, this makes the classification correct for testing data that is identically distributed to training data. _{[0]}Other classification approaches, including Naïve Bayes, Bayesian networks, decision trees, neural networks, fuzzy logic models, maximum entropy models, etc., can be employed. Classification as used herein also is inclusive of statistical regression that is utilized to develop models of priority.

As will be readily appreciated from the subject specification, the subject invention can employ classifiers that are pre-trained (e.g., via a generic training data from multiple users) as well as methods of reinforcement learning (e.g., via observing user behavior, observing trends, receiving extrinsic information). Thus, the subject invention can be used to automatically learn and perform a number of functions, including but not limited to determining, according to a predetermined criteria, candidates to select, times for meetings, restore state of an application upon completion of a call, etc.

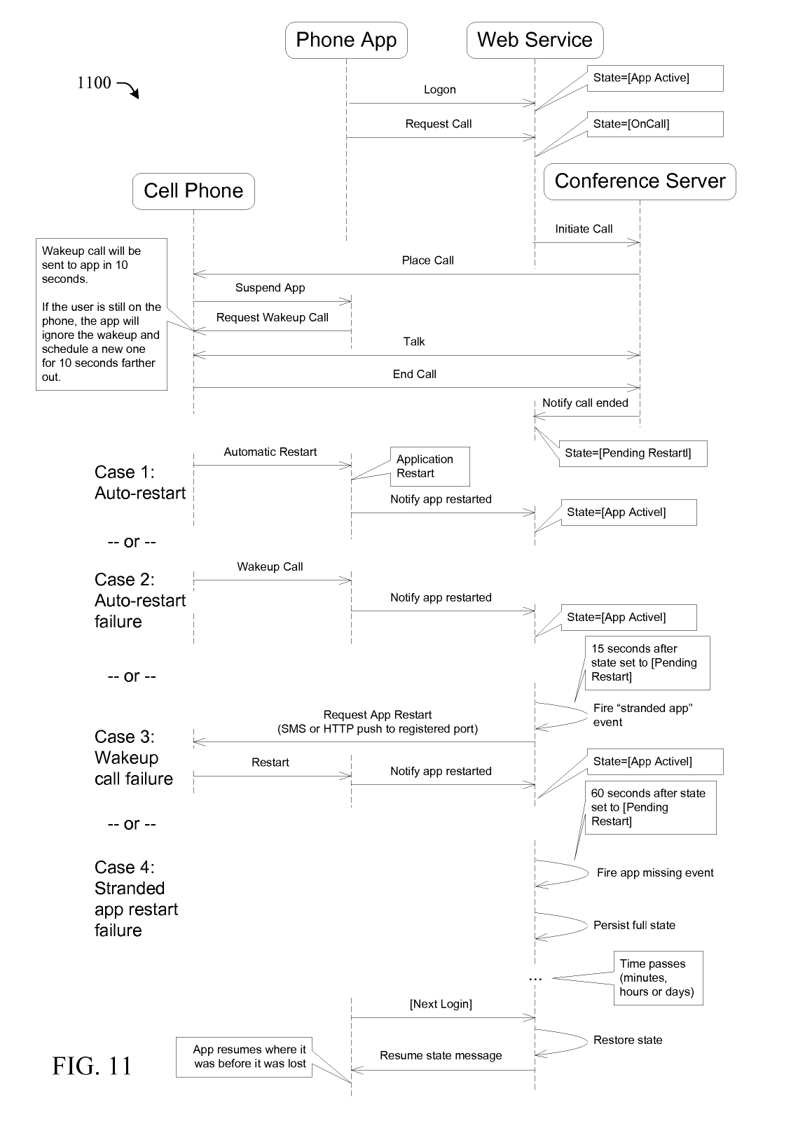

Turning now to FIG. 11, a failsafe application restart process flow in accordance with an aspect of the innovation is shown. More particularly, FIG. 11 illustrates four exemplary process flow case scenarios that correspond to alternative aspects of the innovation.

Although specific process flow scenarios are shown in FIG. 11, it is to be understood and appreciated that other aspects can exist and are to be included within the scope of the disclosure and claims appended hereto. As well, it is to be understood that the case scenarios illustrated can vary based upon other situational factors and/or preferences.

For example, with reference to case 4, upon resume, it is not imperative that the application install at the state before it became lost. As well, the application can could have been lost or abandoned on a separate device. Once restarted on another device, the state could be resumed on the replacement device. All in all, the novel aspects of interruption and restart can be applied to countless scenarios, each of which is to be included within the scope of the innovation and claims appended hereto.

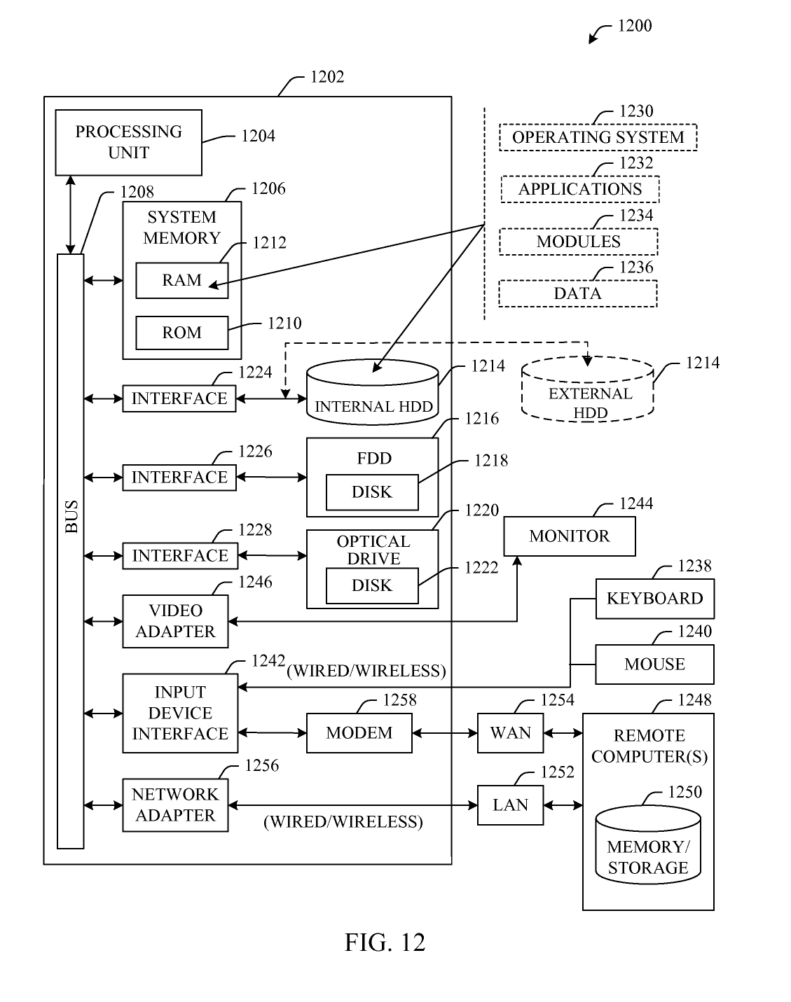

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g. a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g. a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

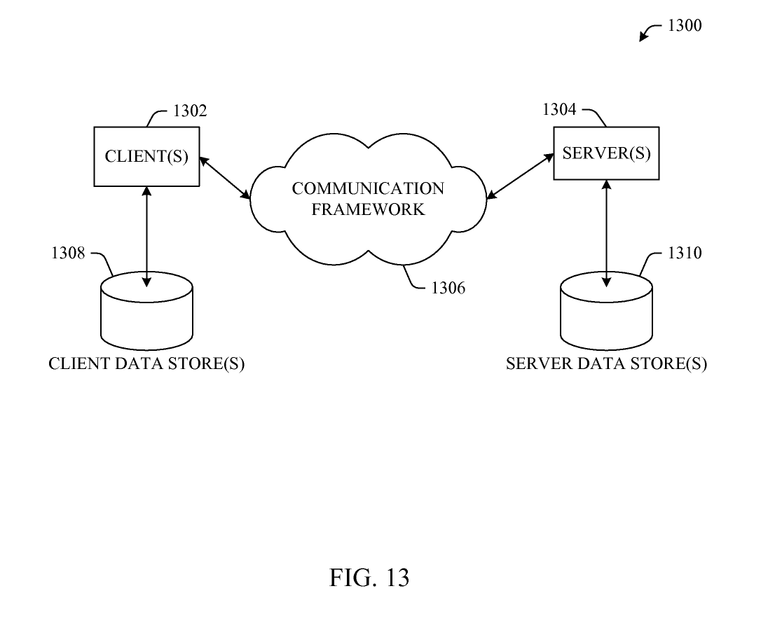

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A communication system that facilitates unidentified communication between a first and a second device, comprising:
a connection interface component that schedules an exchange between the first and the second device; and
an anonymous communication component that establishes the exchange such that an identity of each party to the exchange is unknown.

2. The communication system of claim 1, the connection interface component includes a social interaction service component that enables one of the first and the second devices to select the other of the first and second devices.

3. The communication system of claim 2, the connection interface component includes a state suspend component that records a state of the social interaction service component prior to the establishment of the exchange.

4. The communication system of claim 3, the connection interface component includes a state restore component that automatically re-establishes the state of the social interaction service component upon termination of the exchange.

5. The communication system of claim 4, the social interaction service component includes a selection component that facilitates one of the first and second devices to select the other of the first and second devices.

6. The communication system of claim 5, the anonymous communication component facilitates audible communication between the first and the second device

7. The communication system of claim 5, the anonymous communication component facilitates visual communication between the first and second device.

8. The communication system of claim 5, the anonymous communication component facilitates text communication between the first and the second device.

9. The communication system of claim 1, the connection interface component further comprises a schedule component that arranges a time for the exchange based at least in part upon a preference of a user of at least one of the first and second device.

10. The communication system of claim 6, the schedule component includes an application launch component that automatically launches a social interaction service component upon the time.

11. The communication system of claim 1, at least one of the first and second device is a wireless mobile phone.

12. A system that facilitates anonymous communication, comprising:
a social interaction component having a plurality of candidates therein; each candidate employs a device having a communication interface; and
a server that anonymously connects a device of a user with the devices of a subset of the plurality of candidates.

13. The system of claim 12, the server includes a connection manager that masks identity of the user and of each of subset of the plurality of candidates.

14. The system of claim 13, each communication interface includes a service that facilitates selection of the subset of the plurality of candidates.

15. The system of claim 13, each communication interface records a service state and suspends the service prior to the anonymous connection between the user and the subset of the plurality of candidates.

16. The system of claim 15, each communication interface automatically restores the state of the service upon termination of the anonymous connection.

17. The system of claim 12, further comprising an artificial intelligence (AI) component that infers an action that the user desires to be automatically performed.

18. A computer-implemented method of social interaction, comprising:
launching a social interaction application;
scheduling a meeting between a user and a candidate;
suspending the social interaction application;
commencing the meeting with the candidate;
terminating the meeting; and
restarting the social interaction application.

19. The computer-implemented method of claim 18, further comprising recording a state of the social matching application upon commencement of the meeting and restarting the social interaction application based at least in part upon the state upon termination of the meeting.

20. The computer-implemented method of claim 18, further comprising masking identities of the user and the candidate.

21. The computer-implemented method of claim 18, the act of commencing the meeting originates via at least one of a wireless device, a landline and a VOIP equipped personal computer.

22. The computer-implemented method of claim 21, further comprising transferring the meeting to at least one of a wireless device, a landline and a VOIP-equipped equipped personal computer.

23. The computer-implemented method of claim 18, further comprising selecting the candidate from a plurality of candidates.

24. The computer-implemented method of claim 23, the act of selecting comprises querying a database that includes a plurality of profiles that correspond to the plurality of candidates.

25. The computer-implemented method of claim 23, the act of selecting comprises querying tags related to the plurality of candidates.

26. The computer-implemented method of claim 23, the act of selecting comprises randomly selecting the candidate from the plurality of candidates.

27. The computer-implemented method of claim 23, the act of selecting comprises inferring the selection of the candidate based at least in part upon artificial intelligence.
